(19) United States
(12) Patent Application Publication
(10) Pub. No.: US 2007/0124694 A1
(43) Pub. Date: May 31, 2007

(54) Gesture to define location, size, and/or content of content window on a display

(75) Inventors: Bartel Marinus Van De Sluis, Eindhoven (NL); Jan B.A.M. Horsten, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/574,137

(22) PCT Filed: Sep. 27, 2004
(86) PCT No.: PCT/IB04/51882

§ 371 Date: Mar. 29, 2006

Related U.S. Application Data
(60) Provisional application No. 60/507,287, filed on Sep. 30, 2003.

(51) Int. Cl. G06F 3/00

(52) U.S. Cl. 715/775

(57) ABSTRACT

A display including: a display surface (108, 300) for displaying content to a user; a computer system (110) for supplying the content to the display surface (108, 300) for display in a content window (112, 306) on the display surface (108, 300); and a recognition system (128) for recognizing a gesture of a user and defining at least one of a size, location, and content of the content window (112, 306) on the display surface (108, 300) based on the recognized gesture. The display can be a display mirror (108) for reflecting an image of the user at least when the content is not being displayed. Furthermore, the gesture can be a hand gesture of the user.

The present invention relates generally to displays, and more particularly, to gestures for defining the location, size, and/or content of content windows on display mirrors.

Display mirrors are known in the art, such as that disclosed in U.S. Pat. No. 6,560,027 to Meine. A display mirror is able to display a content window with information, communication, or entertainment (ICE) content on a particular area of the mirror. The window generally has a fixed position on the mirror display. Applications of mirror displays are envisioned for bathrooms, kitchens, kiosks, elevators, building lobbies etc. Depending on the location of the user (user-display distance) and the user activity (e.g., how the user's attention is balanced between the mirror and content window), the user may want to influence one or more of the size of the content window, its location on the mirror display, and/or the content in the window. This can be a challenge since the user interface for the mirror display may not be known to the user. Traditional input solutions such as a keyboard and pointing device (e.g., mouse, rollerball) may not be appealing or applicable in many situations. Furthermore, remote controls may not be useful in some applications. An obvious solution used in other interactive displays, touch screens, are of limited use because the mirror quality can be affected and any touching will contaminate or otherwise degrade the mirror surface.

Furthermore, the size and resolution of displays is expected to grow rapidly in the near future making way for large displays that can cover a wall or desk. Such large displays will also be capable of displaying content windows and in some situations may have the same problems associated with indicating a size and location for rendering the content window on the display as discussed above.

Therefore it is an object of the present invention to provide a display that overcomes these and other disadvantages associated with the prior art.

Accordingly, a display is provided. The display comprising: a display surface for displaying content to a user; a computer system for supplying the content to the display surface for display in a content window on the display surface; and a recognition system for recognizing a gesture of a user and defining at least one of a size, location, and content of the content window on the display surface based on the recognized gesture.

The display can be a display mirror for reflecting an image of the user at least when the content is not being displayed. The display mirror can display both the content and the image of the user.

The recognition system can comprise: one or more sensors operatively connected to the computer system; and a processor for analyzing data from the one or more sensors to recognize the gesture of the user. The one or more sensors can comprise one or more cameras, wherein the processor analyzes image data from the one or more cameras to recognize the gesture of the user. The recognition system can further comprise a memory for storing predetermined gestures and an associated size and/or position of the content window, wherein the processor further compares the recognized gesture of the user to the predetermined gestures and renders the content window in the associated size and/or position. The memory can further include an associated content, wherein the processor further compares the recognized gesture of the user to the predetermined gestures and renders the associated content in the content window. The processor and memory can be contained in the computer system.

The display can further comprise a speech recognition system for recognizing a speech command of the user and rendering a content in the content window based on the recognized speech command.

The gesture can further define a closing of an application displayed on the display surface.

The display can further comprise one of a touch-screen, close-touch, and touchless system for entering a command into the computer system.

Also provided is a method for rendering a content window on a display. The method comprising: supplying content to the display for display in the content window; recognizing a gesture of a user; defining at least one of a size, location, and content of the content window on the display based on the recognized gesture; and displaying the content window on the display according to at least one of the defined size, location, and content.

The gesture can be a hand gesture.

The display can be a display mirror where the displaying comprises displaying both the content and an image of the user. The display can also be a display mirror where the displaying comprises displaying only the content.

The recognizing can comprise: capturing data of the gesture from one or more sensors; and analyzing the data from the one or more sensors to recognize the gesture of the user. The one or more sensors can be cameras where the analyzing comprises analyzing image data from the one or more cameras to recognize the gesture of the user. The analyzing can comprise: storing predetermined gestures and an associated size and/or position of the content window; comparing the recognized gesture of the user to the predetermined gestures; and displaying the content window in the associated size and/or position. The storing can further include an associated content for the predetermined gestures, wherein the displaying further comprises displaying the associated content in the content window.

The method can further comprise recognizing a speech command of the user and rendering a content in the content window based on the recognized speech command.

The method can further comprise defining a closing of an application displayed on the display based on the recognized gesture.

The method can further comprise providing one of a touch-screen, close-touch, and touchless system for entering a command into the computer system.

Still provided is a method for rendering a mirror display content window on a display where the mirror display content window displays both content and an image of a user. The method comprising: supplying the content to the display for display in the mirror display content window; recognizing a gesture of a user; defining at least one of a size, location, and content of the mirror display content window on the display based on the recognized gesture; and displaying the mirror display content window on the display according to at least one of the defined size, location, and content.

Still yet provided are a computer program product for carrying out the methods of the present invention and a program storage device for the storage of the computer program product therein.

These and other features, aspects, and advantages of the apparatus and methods of the present invention will become better understood with regard to the following description, appended claims, and accompanying drawings where:

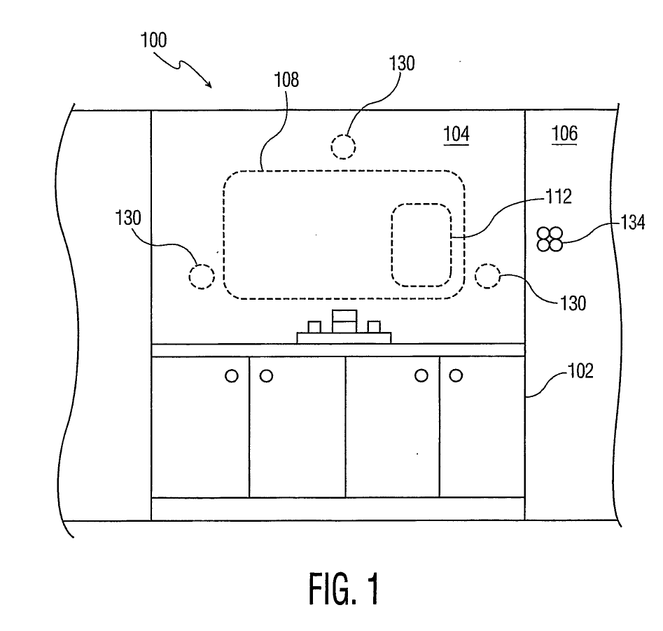

FIG. 1 illustrates an embodiment of a display mirror integrated into a bathroom mirror.

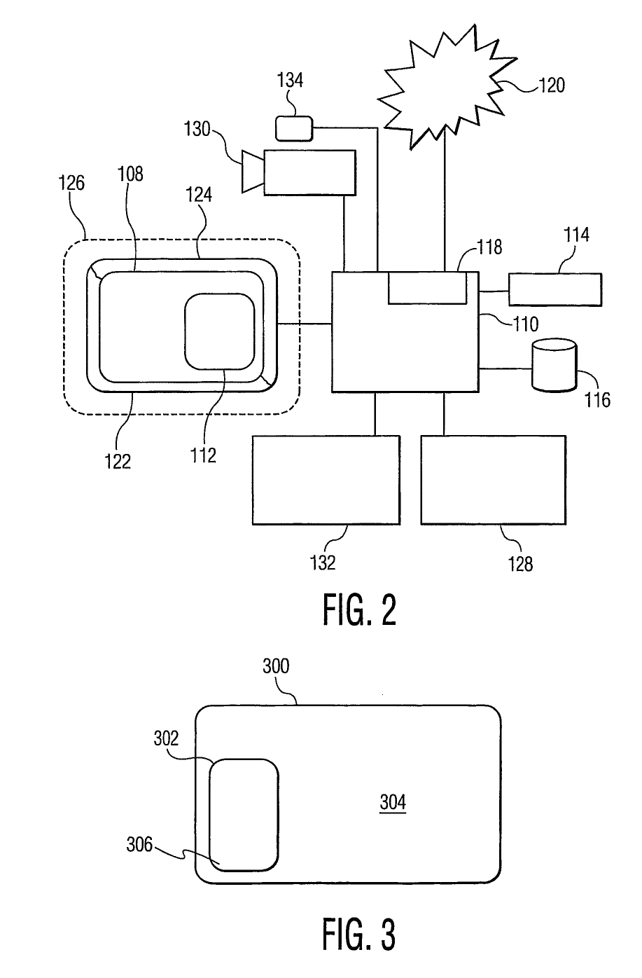

FIG. 2 illustrates a schematic of the display mirror of FIG. 1.

FIG. 3 illustrates an alternative display for use in the schematic of FIG. 1.

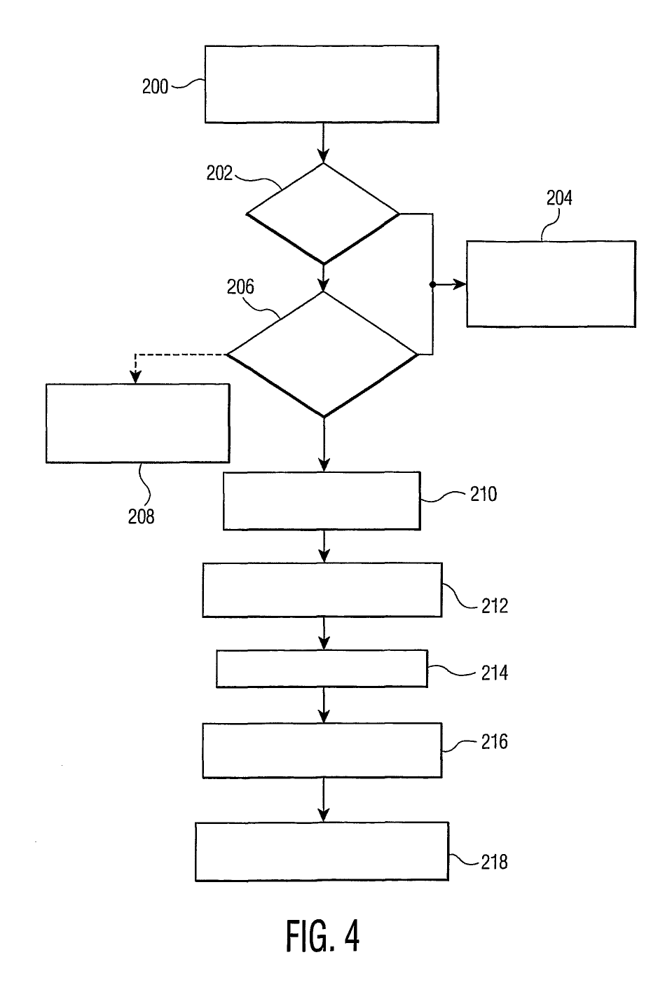

FIG. 4 illustrates a flow chart of a preferred method for rendering a content window on a display mirror.

Although this invention is applicable to numerous and various types of displays, it has been found particularly useful in the environment of bathroom display mirrors. Therefore, without limiting the applicability of the invention to bathroom display mirrors, the invention will be described in such environment. However, those skilled in the art will appreciate that the present invention has application in other types of displays, particularly large displays and in other types of display mirrors, such as those disposed in kitchens, kiosks, elevators, and building and hotel lobbies.

Furthermore, although the present invention is applicable to numerous and various types of gestures, it has been found particularly useful in the environment of hand gestures. Therefore, without limiting the applicability of the invention to hand gestures, the invention will be described in such environment. However, those skilled in the art will appreciate that the other types of gestures are equally applicable in the apparatus and methods of the present invention, such as gestures involving other parts of a person's anatomy such as fingers, arms, elbow, and even facial gestures.

The present invention is directed to a system and method that comprises an information display panel and a mirror to form a display mirror, such as that disclosed in U.S. Pat. No. 6,560,027 to Meine, the disclosure of which is incorporated herein by its reference. Such a display mirror is preferably placed in the bathroom, since a person spends a certain amount of time in the bathroom preparing for the day. The display mirror would allow a person to review electronic news and information, as well as their schedule, while preparing for the day, e.g. brushing teeth, shaving, styling hair, washing, applying makeup, drying off, etc. By allowing interaction with the display mirror, a person could revise their schedule, check their e-mail, and select the news and information that they would like to receive. The user could look at the smart mirror and review news headlines and/or stories, read and respond to e-mails, and/or review and edit their schedule of appointments.

Referring now to FIG. 1, a preferred embodiment of a display mirror for displaying information, communication, or entertainment content is illustrated in a bathroom 100. For purposes of this disclosure, “content” means any thing that can be displayed to a user in a window, including but not limited to a listing of e-mail, a web page, a software application, a television or other video content, as well as functions that can be carried out by the user, such as controlling the lighting or security in a room or rooms of a building. The bathroom 100 having a vanity 102 having an associated mirror 104 disposed on a wall 106 of the bathroom 100. As discussed above, the bathroom is shown by way of example only and not to limit the scope and spirit of the present invention.

A display mirror 108 is incorporated into at least a portion of the surface of the mirror 104. An outline of the display mirror 108 is shown in FIG. 1 by dashed lines. Although the display mirror 108 is shown generally centered in the mirror 104, it could be located at any position on the mirror 104, such as along one side, or in a corner of the mirror 104. Furthermore, although, the display mirror 108 is shown covering a substantial portion of the mirror 104, it can be smaller or larger without departing from the scope or spirit of the present invention. The display mirror 108 displays information, communication, or entertainment (ICE) content to a user and can also reflect an image of the user at least when the ICE content is not being displayed. Generally, the display mirror has two modes. In a power off mode, the smart mirror acts as a standard reflective mirror. In a power on mode, the smart mirror becomes a display device. The display mirror 108 could be formed from a liquid crystal screen. In a power off mode, the display mirror 108 acts as a standard reflective mirror. Any object placed in front of the mirror would cause a reflected image to be formed. The reflective operation of the mirror may be turned off when the display device 108 is turned on. Thus, objects placed in front of the mirror would not generate reflected images, and only the display information is shown to the user.

Alternatively, the reflective operation can be overlaid with the display operation. The information being displayed by the device would appear to the user to originate on the surface of the display mirror 108. The reflected image of the user that is provided to the user appears to originate at a certain distance behind the mirror 104 (the certain distance being equal to the distance between the source object (e.g. the user) and the mirror 104 surface). Thus, a user could switch between their own reflected image and the display information by changing the focus of their eyes. This would allow a user to receive information while performing sight intensive activities, e.g. shaving or applying makeup. Thus, the display mirror 108 can simultaneously display both ICE content and the image of the user or can display only the ICE content without reflecting the image of the user. In the bathroom example shown in FIG. 1, it is preferred that the display mirror 108 display both the ICE content and a reflection of the user so that the user can simultaneously review the ICE content and perform other chores such as shaving or applying makeup.

As discussed above, a display mirror is given by way of example only and not to limit the scope or spirit of the present invention. The display can be any type of display which is capable of rendering a content window and which is operatively connected to a control for resizing and/or moving the content window and supplying content for rendering in the content window. Such a display can be a large display disposed on a substantial portion of a wall or on a desk and which can benefit from the methods of the present invention for defining the location, size, and/or content of the content window using gestures.

Referring now to the schematic of FIG. 2, the display mirror 108 includes a computer system 110 for supplying the ICE content to the display mirror 108 for display in a content window 112 on the display mirror 108. The computer system 110 includes a processor 114 and a memory 116 which may be integral with the computer system 110 or operatively connected thereto. The computer system may be a personal computer or any other device having a processor which can supply ICE content to the display mirror 108, such as a television receiver, a DVD player, a set-top box and the like. The computer system 110 further includes a modem 118 or other similar means for contacting a remote network, such as the Internet 120. The Internet connection can be by any means known in the art, such as ISDN, DSL, plain old telephone, or cable and can be wired or wireless. The connection to the Internet enables a user of the display mirror 108 to send/receive e-mails, as well as display web information. This would allow the user to configure the display mirror 108 to display desired information, e.g. news, stocks, etc, from selected sources, e.g. CNN, UPI, stock companies, etc. The connection to the computer system 110 would also allow access to the user's appointment schedule that may be stored in the memory 116. The user could then review and/or change the appointments, tasks, and/or notes in the schedule or calendar. The user could then have the schedule downloaded to a personal data assistant, e.g. palm pilot, or printed out for inclusion with an appointment book. The user could also e-mail the schedule to a work location or to another person, e.g. administrative assistant. The computer system 110 can be dedicated to the display mirror 108 and networked to other computers or the computer system 110 can be connected to the display mirror 108 by wired or wireless networking and used for other purposes. The computer system 110 may also be configured to operate and control a plurality of display mirrors 108 located at a single location or at multiple locations.

The display mirror further includes a means for entering instructions to the computer system 110 for carrying out commands or entering data. Such a means can be a keyboard, mouse, roller ball or the like. However, the display mirror 108 preferably includes one of a touch-screen, close-touch, and touchless system (collectively referred to herein as a touch-screen) for entering commands and/or data into the computer system 110 and allow direct user interaction. Touch screen technology is well known in the art. In general, a touch-screen relies on the interruption of an IR light grid in front of the mirror display 108. The touch-screen includes an opto-matrix frame containing a row of IR-light emitting diode (LEDs) 122 and phototransistors 124, each mounted on two opposite sides to create a grid of invisible infrared light. A frame assembly 126 is comprised of printed wiring boards on which the opto-electronics are mounted and is concealed behind the mirror 104. The mirror 104 shields the opto-electronics from the operating environment while allowing the IR beams to pass through. The processor 114 sequentially pulses the LEDs 122 to create a grid of IR light beams. When a stylus, such as a finger, enters the grid, it obstructs the beams. One or more of the phototransistors 124 detect the absence of light and transmit a signal that identifies the x and y coordinates. A speech recognition system 132 may also be provided for recognizing a speech command from a microphone 134 operatively connected to the computer system 110. The microphone is preferably located behind acoustic openings in the wall 106 where water and other liquids are less likely to damage the microphone 134.

Where the display mirror is used in a relatively hostile environment, such as in the bathroom 100, then additional elements may be necessary. For example, the display mirror 108 may use an anti-fog coating and/or a heating system to prevent steam/fog build up on the display. Also the computer system 110 and the mirror display 108 should be sealed from moisture (both steam and liquid water), which could cause corrosion. The mirror display 108 should also tolerate rapid temperature changes, as well as extremes of high and low temperatures. Similarly, the mirror display 108 should tolerate extremes of high and low humidity changes, as well as rapid changes in humidity.

The display mirror 108 also includes a recognition system 128 and one or more sensors for recognizing a hand gesture of a user and defining at least one of a size, location, and content of the content window 112 on the display mirror 108 based on the recognized hand gesture. The recognition system 128 may be a standalone dedicated module or embodied in software instructions in the memory 116 which are carried out by the processor 114. In one embodiment, the recognition system 128 is a computer vision system for recognizing hand gestures, such computer vision systems are well known in the art, such as that disclosed in U.S. Pat. No. 6,396,497 to Reichlen, the disclosure of which is incorporated herein by its reference. In the computer vision system the one or more sensors are one or more image capturing devices, such as digital video cameras 130 positioned behind the mirror 104 but able to capture images in front of the mirror 104. Preferably, three such video cameras are provided, shown in FIG. 1 by dashed circles and are positioned such that the user's hand gestures will be in the field of view of at least two of the three video cameras 130. Alternatively, one or more of the video cameras 130 can be provided with pan-zoom-tilt motors (not shown) where the recognition system 128 also detects the user's hands and commands the pan-tilt-zoom motors to track the hands.

In one embodiment, images or video patterns that match predetermined hand gesture models are stored in the memory 116. The memory 116 further includes an associated size, position, and/or content for the content window 112 for each of the predetermined hand gestures. Therefore, the processor 114 compares the recognized hand gesture of the user to the predetermined hand gestures in the memory 116 and renders the content window 112 with the associated size, position, and/or content. The comparing can comprise determining a score for the recognized hand gesture as compared to a model, and if the scoring is above a predetermined threshold, the processor 114 carries out the rendering of the content window 112 according to the associated data in the memory 116. The hand gesture can further define a command such as closing of an application displayed on the display mirror surface.

If two or more cameras 130 are used, location of the hand gesture can also be calculated by triangulation. Therefore, as an alternative to the rendering of the content window 112 according to the associated data in the memory 116, a hand gesture location value can be determined from the detected location of the hand gesture and the content window 112 rendered in a corresponding location. Similarly, a hand gesture size value can be calculated from the detected hand gesture and the content window 112 rendered in a corresponding size.

Although the recognition system has been described with regard to a computer vision system, those skilled in the art will appreciate that the predetermined hand gestures may also be recognized by other means, such as thermal imaging, ultrasound, a touch screen which requires a gesture to be made on the display surface, or touchless interaction (e.g., capacitive sensing).

The operation of the mirror display 108 will now be described in general with regard to FIG. 4. At step 200, the computer system 110 receives a command to render a content window 112. The command may be a touch command, spoken command, or may even be integral with the hand gesture. For example, a hand gesture may signal both an opening of a content window 112 and the size and/or location to render the content window 112 on the display mirror 108. At step 202, the recognition system 128 determines whether a hand gesture is detected. If no hand gesture is detected, the method proceeds to step 204 where the content window is rendered according to predetermined default settings, such as size and/or location. If a hand gesture is detected, it is determined if the hand gesture matches one of the predetermined hand gestures stored in memory 116 at step 206. If the detected hand gesture is not a “content window hand gesture” (one of the predetermined hand gestures stored in the memory 116), again, the content window is rendered according to the predetermined default settings at step 204. Where the content window 112 is rendered according to the associated data in the memory 112 that indicates the size, location, and/or content of the content window, the method proceeds to step 208, indicated by a dashed line.

Alternatively, the method proceeds from step 206-Y to step 210 where a gesture location value is calculated. As discussed above, the location of the hand gesture can be determined using a triangulation method with the video data from at least two of the three video cameras 130. The gesture location value is then translated into a content window 112 location at step 212. For example, if the hand gesture is detected as being in the upper right hand corner of the display mirror 108, the content window 112 can be rendered in an upper right hand corner of the display mirror 108. At step 214, a gesture size value is calculated based on the size of the hand gesture detected. At step 216, the gesture size value is then translated into a content window size. For example, where the hand gesture is a closed fist, a small content window 112 is rendered in a location according to the calculated location value. If an open palm hand gesture is detected, a large content window 112 can be rendered. The size of the content window 112 corresponding to a detected hand gesture can be stored in memory 116 or based on an actual detected size of the hand gesture. Thus, if a closed fist hand gesture results in a first size content window 112 and an open palm hand gesture results in a larger second size content window 112, a hand gesture having a size in between the closed fist and open hand would result in a content window 112 having a size between the first and second sizes. Once the content window 112 is opened, its size can be adjusted by adjusting the size of the hand gesture, possibly in combination with a spoken command recognized by the speech recognition system 132. At step 218, the content window 112 is rendered according to the content window size and/or location. Although, the method has been described with regard to both size and location, those skilled in the art will appreciate that either can be used without the other, if so desired.

The content that is rendered in the content window 112 (e.g., a particular web site, the user's e-mail mailbox, etc.) can be known to the computer system from a user input or user programmed. For example, the user can specify the content from a menu using the touch screen or the speech recognition system 132 just prior to making a hand gesture for moving or resizing the content window 112. The user can also preprogram a certain content to be rendered at different times of the day. For example, render a news web site in the morning followed by a listing of e-mail messages and a music video clip, such as MTV in the evening. The recognition system 128 may also be used to recognize certain individuals from a family or business and render content according to each individual's preset programming or hand size.

The content to be rendered in the content window 112 can also be specified by the user during the hand gesture, such as by issuing a voice command simultaneously with the hand gesture. The content to be rendered in the content window 112 can also be specified by the user after the hand gesture is made, for example, by presenting a menu in the content window and requiring the user to further select from the menu, possibly with another hand gesture, by touch screen, or by a spoken command. The hand gesture itself may also serve to specify the content rendered in the content window in addition to indicating the size and/or location of the content window 112 on the display mirror 108. For example, the user can make a C-shaped hand gesture at the top right hand corner of the display mirror 108 in which case CNN will be rendered in a content window 112 in a top right hand corner of the display mirror 108. Furthermore, the C-shape of the hand gesture can be widely opened to indicate a large window or closed to indicate a small window. Similarly, a M-shaped hand gesture can be used to specify a music content to be rendered in the content window 112 or an R shaped hand gesture can be made in specify a radio content. Also, a certain hand gesture location and/or size may correspond to a particular content to be rendered in the content window 112. For example, a top left hand gesture can correspond to CNN content rendered in the content window 112 and a lower right hand gesture may correspond to the cartoon network being rendered in the content window 112. As discussed briefly above, the detected hand gesture may also be used to close a content window 112, such as an “X” or wiping motion. If more than one content window 112 is open, the closing hand gesture can be applied to the content window 112 that most closely corresponds with the location of the hand gesture.

The embodiments discussed above are useful for opening, closing, resizing, and moving a content window displayed on a display mirror 108. However, as shown in FIG. 3, a non-mirrored display 300 such as an LCD panel display, can be substituted in the system shown schematically in FIG. 2. The non-mirrored display 300 is capable of rendering a mirrored-like portion 302 on a display surface 304. Thus, a system using such a non-mirrored display 300 can render a content window 306 having a mirrored background similar to that described above with regard to the display mirror 108. However, the area surrounding the content window 306 would not be mirrored or have a mirrored effect. The system can then be used to open, close, resize, and/or move the content window 306 similarly to that described above.

The methods of the present invention are particularly suited to be carried out by a computer software program, such computer software program preferably containing modules corresponding to the individual steps of the methods. Such software can of course be embodied in a computer-readable medium, such as an integrated chip or a peripheral device.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claim

1. A display comprising:
a display surface (108, 300) for displaying content to a user;
a computer system (110) for supplying the content to the display surface (108) for display in a content window (112, 306) on the display surface (108, 300); and
a recognition system (128) for recognizing a gesture of a user and defining at least one of a size, location, and content of the content window (112, 306) on the display surface (108) based on the recognized gesture.

2. The display of claim 1, wherein the display is a display mirror for reflecting an image of the user at least when the content is not being displayed.

3. The display of claim 2, wherein the display mirror displays both the content and the image of the user.

4. The display of claim 1, wherein the recognition system (128) comprises:
one or more sensors operatively connected to the computer system (110); and
a processor (114) for analyzing data from the one or more sensors to recognize the gesture of the user.

5. The display of claim 4, wherein the one or more sensors comprise one or more cameras (130), wherein the processor analyzes image data from the one or more cameras (130) to recognize the gesture of the user.

6. The display of claim 4, wherein the recognition system (128) further comprises a memory (116) for storing predetermined gestures and an associated size and/or position of the content window (112, 306), wherein the processor (114) further compares the recognized gesture of the user to the predetermined gestures and renders the content window (112) in the associated size and/or position.

7. The display of claim 6, wherein the memory (116) further includes an associated content, wherein the processor (114) further compares the recognized gesture of the user to the predetermined gestures and renders the associated content in the content window (112, 306).

8. The display of claim 6, wherein the processor (114) and memory (116) are contained in the computer system (110).

9. The display of claim 1, further comprising a speech recognition system (132) for recognizing a speech command of the user and rendering a content in the content window (112, 306) based on the recognized speech command.

10. The display of claim 1, wherein the gesture further defines a closing of an application displayed on the display surface (108, 300).

11. The display of claim 1, further comprising one of a touch-screen, close-touch, and touchless system (122, 124, 126) for entering a command into the computer system.

12. A method for rendering a content window (112, 302) on a display (108, 300), the method comprising:
supplying content to the display (108, 300) for display in the content window (112, 306);
recognizing a gesture of a user;
defining at least one of a size, location, and content of the content window (112, 306) on the display (108, 300) based on the recognized gesture; and
displaying the content window (112, 306) on the display (108, 300) according to at least one of the defined size, location, and content.

13. The method of claim 12, wherein the gesture is a hand gesture.

14. The method of claim 12, wherein the display (108, 300) is a display mirror (108) and the displaying comprises displaying both the content and an image of the user.

15. The method of claim 12, wherein the display (108) is a display mirror and the displaying comprises displaying only the content.

16. The method of claim 12, wherein the recognizing comprises:
capturing data of the gesture from one or more sensors; and
analyzing the data from the one or more sensors to recognize the gesture of the user.

17. The method of claim 16, wherein the one or more sensors are cameras (130) and the analyzing comprises analyzing image data from the one or more cameras (130) to recognize the gesture of the user.

18. The method of claim 16, wherein the analyzing comprises:
storing predetermined gestures and an associated size and/or position of the content window;
comparing the recognized gesture of the user to the predetermined gestures; and
displaying the content window (112, 306) in the associated size and/or position.

19. The method of claim 18, wherein the storing further includes an associated content for the predetermined gestures, wherein the displaying further comprises displaying the associated content in the content window (112, 306).

20. The method of claim 12, further comprising recognizing a speech command of the user and rendering a content in the content window (112, 306) based on the recognized speech command.

21. The method of claim 12, further comprising defining a closing of an application displayed on the display (108, 300) based on the recognized gesture.

22. The method of claim 12, further comprising providing one of a touch-screen, close-touch, and touchless system (122, 124, 126) for entering a command into the computer system (110).

23. A computer program product embodied in a computer-readable medium for rendering a content window (112, 306) on a display (108, 300), the computer program product comprising:
computer readable program code means for supplying content to the display (108, 300) for display in the content window (112, 306);
computer readable program code means for recognizing a gesture of a user;
computer readable program code means for defining at least one of a size, location, and content of the content window (112, 306) on the display (108, 300) based on the recognized gesture; and
computer readable program code means for displaying the content window (112, 306) on the display (108, 300) according to at least one of the defined size, location, and content.

24. A method for rendering a mirror display content window (306) on a display (300), the mirror display content window (306) displaying both content and an image of a user, the method comprising:
supplying the content to the display (300) for display in the mirror display content window (306);
recognizing a gesture of a user;
defining at least one of a size, location, and content of the mirror display content window (306) on the display (300) based on the recognized gesture; and
displaying the mirror display content window (306) on the display (300) according to at least one of the defined size, location, and content.
